(19) United States
(12) Patent Application Publication
(10) Pub. No.: US 2005/0136177 A1
(43) Pub. Date: Jun. 23, 2005

(54) Method for coloring landscaping materials using foamable dry colorant

(76) Inventor: Anthony Hesse, Toms River, NJ (US)

Correspondence Address: GEORGE WHEELER;McANDREWS, HELD & MALLOY, Ltd., 34th FLOOR, 500 W. MADISON ST., CHICAGO, IL, 60661, US

(21) Appl. No.: 10/924,747

(22) Filed: Aug. 24, 2004

Related U.S. Application Data
(60) Provisional application No. 60/497,655, filed on Aug. 25, 2003.

(51) Int. Cl. B05D 5/00; C08K 5/00

(52) U.S. Cl. 427/4; 427/243; 106/499

(57) ABSTRACT

According to one exemplary embodiment of the present invention, a method of making a dry landscaping material colorant is described comprising mixing a colorant pigment and a binder to form a dry colorant. The binder includes a surfactant in an amount sufficient to foam the dry colorant when the water is added to the dry colorant.

This application claims priority to Provisional Application No.: 60/497,655 filed Aug. 25, 2003, the specification of which is incorporated herein in its entirety.

### BACKGROUND

Currently, there are known “dry” systems for coloring landscaping materials, such as wood mulch. The dry system includes pigments in powder, granule or pellet form which are added to color the mulch during or after the mulch is processed into particulated material. Often this dry method is insufficient to adequately and suitably color the mulch.

### DETAILED DESCRIPTION

According to one exemplary embodiment of the present invention, a method of making a dry landscaping material colorant is described comprising mixing a colorant pigment and a binder to form a dry colorant. The binder includes a surfactant in an amount sufficient to foam the dry colorant when the water is added to the dry colorant.

U.S. Pat. Nos. 4,946,505 to Jungk, 5,484,481 to Linde et al., 5,215,583 to Krockert et al., 5,718,755 to Kohler et al., 3,068,109 to Rodeffer, and 6,596,072 to Dunnous et al., all of which are incorporated by reference herein, disclose colorant products and methods for making and/or using such products. Any of the products listed therein, and including dry colorant products currently or previously supplied by companies for manufacture of concrete and landscaping materials, such as Morbark, Inc. of Winn, Mich., Interstar of Quebec, Canada, Bandit Industries, Inc. of Remus, Mich., Hamburger Color Company of King of Prussia, Pa., Amerimulch/Chromascape of Independence, Ohio and Rockwood Pigments of Beltsville, Md., for example, may be utilized in the present invention with the addition of a surfactant (or an increase in the amount of surfactant, if already present) in an amount sufficient to foam the dry colorant when water is added during coloring of the mulch.

The dry colorant may be in powder, slurry, paste, granule or pellet form. Any known method for mixing pigment and binder into powder, slurry, granule or pellet form, such as those disclosed in the patents listed above, for example, may be used to form the dry colorants of the present invention. For example, pan mixers or pelletizers, drum pelletizers, disc pelletizers, pelletizing or granulating plates, roll dryers, belt dryers, and spray dryers may be employed in the formation of the dry colorants.

The method described herein may be advantageously used to color landscaping materials such as wood mulch, particularized rubber, aggregate, and any of the landscaping materials disclosed in U.S. patent application Ser. No. 10/405,046 filed on Mar. 31, 2003, which is incorporated by reference herein in its entirety.

The pigments used in the dry colorants may be any pigments commonly known to color landscaping materials, including those described in the above referenced application Ser. No. 10/405,046. Some preferred pigments include carbon black and iron oxide. The binders may include any binders commonly used to form dry colorants, including acrylic polymer binders and those disclosed in U.S. Pat. Nos. 4,946,505, 5,484,481, 5,215,583, 5,718,755, 3,068,109, and 6,596,072, listed above. The binder may be, or may include, the surfactant used to produce the foamable dry colorant. The choice of binder may be determined by the type and amount of pigment and/or other additives included in the dry colorant.

The surfactant used in the dry colorant may be the binder which is being used to agglomerate the dry colorant or may comprise an additional additive. The surfactant should comprise a type of surfactant capable of producing foam when added to a liquid, such as water. Further, the surfactant should comprise an amount sufficient to foam the dry colorant when water is added to the dry colorant. The amount of surfactant preferably ranges from about 0.05 to 20 wt % of the dry colorant. Greater amounts may be required depending on the type of surfactant, environmental factors and type of equipment used to grind or color the landscaping materials. More preferably, the surfactant is approximately 8 wt % of the dry colorant. Such water is typically added during a mixing or grinding, or other landscaping material processing step. The addition of the surfactant in an amount sufficient to foam the dry colorant allows the colorant to be more evenly distributed over the landscaping materials and also may enhance the adhesion of the colorant to the landscaping materials.

Suitable surfactants include any anionic, cationic, amphoteric and non-ionic surfactants capable of foaming the dry colorant. Some preferred surfactants include ammonium alkyl ether sulfate, alpha olefin sulfonate, sodium lauryl sulfoacetate, and sodium lauryl sulfate, and those surfactants listed in U.S. patent application Ser. No. 10/405,046 referenced above.

The dry colorant may include other additives, such as those disclosed in U.S. patent application Ser. No. 10/405,046. Some preferred additives include UV reactive curing agents, coatings, hardeners, or binders, oil or oil-like materials capable of enhancing the appearance, fragrance, longevity, and/or insect repellency of the landscaping materials, insecticides, fungicides, herbicides, fertilizers, nutrients, luminescent, fluorescent, or phosphorescent pigments or other reflective compounds or minerals, and preservatives.

According to another aspect, a method of coloring or otherwise treating landscaping materials includes foaming a dry colorant (and/or other treatment material) to form a foamed dry colorant (and/or treatment material) and applying the foamed dry colorant (and/or treatment material) onto landscaping materials. In one exemplary embodiment, the dry colorant (and/or other treatment material) includes a surfactant, as described above, and the step of applying the foamed dry colorant (and/or other treatment material) onto the landscaping materials includes any of the known processes for coloring landscaping materials, such as mulch, using dry colorants, with the addition of a sufficient amount of water into the system to cause the dry colorants containing surfactant to foam. The dry colorant may be ground with the landscaping materials during processing or may later be ground (if required) and mixed with, dispersed throughout, sprinkled on, or spread over the landscaping materials. The addition of water will cause the dry colorant/surfactant to foam and adhere to the landscaping materials upon breakdown of the foam.

In an alternative embodiment, the step of foaming a dry colorant (and/or other treatment material) to form a foamed dry colorant (and/or other treatment material) includes adding a surfactant, in solid or liquid form, to water which is being delivered to the landscaping materials, which have been mixed with dry colorant, during processing of the landscaping materials. In this embodiment, the addition of surfactant as an element of the dry colorant (and/or other treatment material) is not required. Rather, the surfactant may be added to a water intake line, for example, which is being fed to the landscaping materials during processing. This allows available, non-foaming dry colorants to be used in the present foaming process. In current “dry” coloring procedures for coloring mulch materials, water is usually added during the coloring process. Thus, the current dry processes could be used with the addition of a sufficient amount of surfactant to cause the dry colorant to be foamed when contacted with the water/surfactant mixture.

The step of applying the foamed dry colorant onto the landscaping materials may include using any known landscaping material processing machine, such as those listed in U.S. patent application Ser. No. 10/405,046. Further, any current dry system for coloring mulch materials, such as those sold by Morbark, Inc., Bandit Industries, Inc. and Interstar, for example, may be employed. Preferably a grinder, which may be used to grind the landscaping materials, grinds and disperses the dry colorant (with or without surfactant as an ingredient) throughout the landscaping materials. Either before, simultaneously with, or after the dry colorant is dispersed throughout the landscaping materials, water (including surfactant where such surfactant is not included in the dry colorant in an amount sufficient for foaming) is introduced causing the dry colorant to foam and become adhered to the landscaping materials.

1. A method of making a dry landscaping material colorant comprising:
mixing a colorant pigment and a binder to form a dry colorant, wherein the binder includes a surfactant in an amount sufficient to foam the dry colorant when water is added to the dry colorant.

2. A method of making a dry mulch colorant comprising:
mixing a colorant pigment, a binder and a surfactant to form a dry colorant, wherein the surfactant comprises an amount sufficient to foam the dry colorant when water is added to the dry colorant.

3. The method of claim 1 or 2, wherein the dry colorant is in powder, granule, pellet or slurry form.

4. A method for coloring a landscaping material comprising foaming a dry colorant to form a foamed dry colorant and applying the foamed dry colorant onto landscaping materials.

5. The method of claim 4, wherein the landscaping material comprises mulch.

6. The method of claim 4, wherein the dry colorant is in the form of a powder, slurry, granules, or pellets.

7. The method of claim 4, wherein the dry colorant comprises a pigment and a binder, and wherein the binder includes a surfactant in an amount sufficient to foam the dry colorant when water is added to the dry colorant.

8. The method of claim 4, wherein the dry colorant comprises a pigment, a binder and a surfactant, and wherein the surfactant comprises an amount sufficient to foam the dry colorant when water is added to the dry colorant.

9. The method of claim 4, wherein the steps of foaming a dry colorant and applying the foamed dry colorant onto landscaping materials occurs simultaneously.

10. The method of claim 4, wherein the step of foaming a dry colorant to form a foamed dry colorant includes adding a surfactant to water and delivering the water and surfactant to the landscaping materials, wherein the landscaping materials have been mixed with dry colorant.
